(19) United States
(12) Patent Application Publication
(10) Pub. No.: US 2003/0159604 A1
(43) Pub. Date: Aug. 28, 2003

(54) Device for fixing a flexible plate

(75) Inventors: Georg Schneider, Wurzburg (DE); Karl Robert Schafer, Rimpar (DE)

Correspondence Address: JONES, TULLAR & COOPER, P.C., Eads Station, P.O. Box 2266, Arlington, VA, 22202, US

(73) Assignee: Koenig & Bauer Aktiengesellschaft

(21) Appl. No.: 10/396,497

(22) Filed: Mar. 26, 2003

Related U.S. Application Data
(62) Division of application No. 09/926,646, filed on Nov. 28, 2001, now Pat. No. 6,557,469.
Application No. 09/926,646 is a 371 of international application No. PCT/DE00/01699, filed on May 25, 2000.

(30) Foreign Application Priority Data
May 29, 1999 (DE) 19924784.6

(51) Int. Cl. B41F 27/12

(52) U.S. Cl. 101/415.1

(57) ABSTRACT

A device for fixing a flexible plate having angled or beveled suspension edges to a cylinder utilizes a plurality of fastening elements located in a cylinder groove situated radially inwardly of a fastening slit. The fastening elements are engageable with the suspension legs under the influence of spring forces. Separate fastening elements can be used to engage the leading plate suspension leg depending on the direction of rotation of the cylinder.

The invention relates to devices for fixing a flexible plate on a cylinder of a rotary printing press in accordance with the preamble of claims 1 or 3.

A device for fixing a flexible printing plate on the forme cylinder of a rotary printing press having at least one cylinder groove extending in the axial direction is known from DE 43 35 140 C1.

A first, or leading suspension leg, which is beveled at an acute angle, has been suspended at an edge of the first groove wall of the cylinder groove of the forme cylinder. A second, or trailing, suspension leg can be placed against the second groove wall, extending approximately in the radial direction of the forme cylinder, of the cylinder groove. The cylinder groove contains a spindle which is pivotable around its axis. Two leaf springs, each of which is distributed over the width of the printing plate, are fastened on the spindle and can be brought into, or out of contact with the suspension legs in the course of pivoting the spindle.

DE 196 36 412 C1 discloses a cylinder on which pressure cams for clamping both suspension legs of a printing plate are arranged on a pivotable shaft.

The object of the invention is based on creating a device for fixing a flexible plate on a cylinder of a rotary printing press.

In accordance with the invention, this object is attained by means of the characteristics of claims 1 or 3.

The advantages to be obtained by means of the invention consist in particular in that a rugged, simply constructed device is created, which can be produced cost-effectively. The device in accordance with the invention can be displaced without the turning of a spindle in only two positions. A further advantage of the invention lies in that in its axial extension it can consist of several short base bodies. It is possible because of this to remove the device laterally piece by piece from the cylinder groove, for example for maintenance purposes, without having to dismount the cylinder from the lateral frame. It is of particular advantage that the device can also be employed in case of a reversal of the direction of rotation of the cylinder supporting the plates, for example in connection with satellite printing units. An automatic plate feeding and removal by means of known devices is possible.

An exemplary embodiment of the invention is represented in the drawings and will be described in greater detail in what follows.

Shown are in:

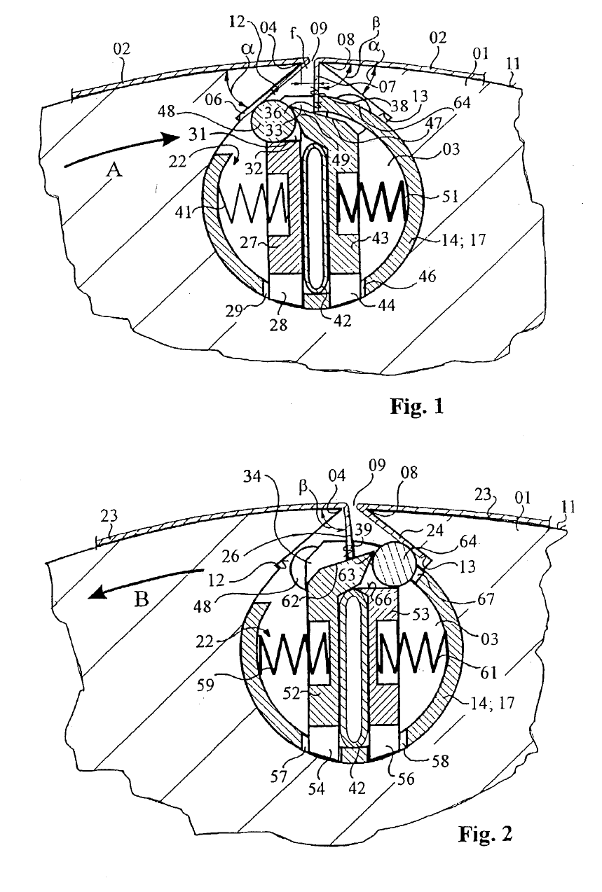

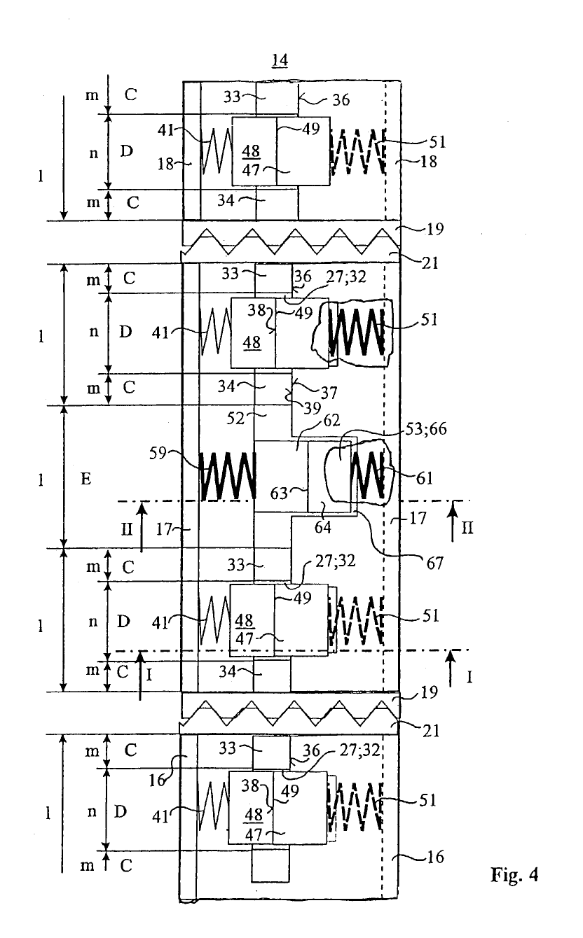

FIG. 1, a section I-I in accordance with FIG. 4, but with the cylinder, the plate and the air hose in a plate-holding or rest position and in an enlarged scale,

FIG. 2, a section II-II in accordance with FIG. 4, but with the cylinder, the plate and the air hose in an enlarged scale,

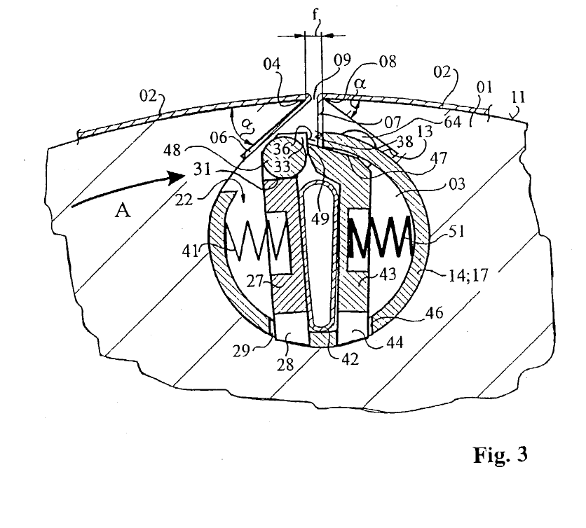

FIG. 3, a device analogous to FIG. 1, with the device in a plate-removing or operating position,

FIG. 4, a view from above on the device, without the cylinder and without the air hose in a partial enlarged representation and limited in the axial direction.

For receiving flexible plates 02, a cylinder 01, for example a plate or rubber blanket cylinder of a rotary printing press, is provided with at least one cylinder groove 03 extending in the axial direction. At a front edge 04 pointing in the production direction A of the cylinder 01, which turns toward the right, or in a clockwise direction of rotation, the cylinder groove 03 has a front, or “leading”, beveled suspension leg 06 of the plate 02 with an opening angle alpha. The plate 02 furthermore has a rear, or “trailing” beveled suspension leg 07, which is suspended from a second, rear edge 08 of the same cylinder groove 03 and has an approximately right opening angle beta (FIG. 1).

It is also possible to arrange two plates, for example printing plates, on the circumference of the cylinder 01. In this case two cylinder grooves are required in the circumferential direction of the cylinder 01.

An acute opening angle alpha, for example up to 45°, is formed between the surface 11 of the cylinder 01 and the first cylinder wall 12 of the cylinder groove 03. The second groove wall 13, extending approximately in the radial direction of the cylinder 01, also has an acute opening angle alpha in respect to the surface 11. Both edges 04, 08, or also vertex points of the opening angles alpha, are separated by a fastening slit 09.

It is possible to also suspend a plate 23 by its suspension legs 24, 26 on the cylinder 01 in such a way that its “leading”, acute-angled suspension leg 24 is suspended at the edge 08, and its “trailing”, approximately right-angled suspension leg 26 at the edge 04. Therefore the “leading” suspension leg 24 points in the production direction B toward the left, i.e. in a counterclockwise direction of rotation (FIG. 2).

The fastening slit 09 is embodied in its inner width f in such a way that at least two suspension legs 06, 07, which project into the cylinder groove 03, can be placed therein next to each other.

In place of a printing plate or several printing plates placed next to each other, it is possible to also fasten flexible support plates with rubber blankets arranged on them.

The cylinder groove 03 can be embodied to be approximately circular in cross section and is connected with the surface 11 through the fastening slit 09.

A base body 14, open in the direction toward the fastening slit 09, is arranged in the cylinder groove 03 and has, for example, a cross section in the form of a longitudinally cut tube (channel-shaped). In accordance with an embodiment variation represented in FIG. 1, this base body 14 can consist in the axial direction of several short base bodies 16, 17, 18, which can be coupled with each other—only three base bodies are represented. Such a coupling can act interlockingly, for example, and can be implemented by sets of teeth 19, 21 on both ends of the base bodies 16, 17, 18. The two outer sets of teeth 19, 21 can be fixed in place at the cylinder cheeks by means of an end coupling element, not represented.

A number of respectively different clamping and/or jamming elements C, D, E are arranged in the interior 22 of each base body 14, or 16 to 18, such as shown by means of the example of the base body 17 in FIG. 4:

first clamping and/or jamming elements C for the respectively “trailing” suspension leg 07, 26 with an approximately right-angled opening angle beta,

second clamping and/or jamming elements D for a suspension leg 06, which is beveled at an acute angle and is “leading” in the production direction A toward the right,

third clamping and/or jamming elements E for a suspension leg 24, which is beveled at an acute angle and is “leading” in the production direction B toward the left.

The channel-shaped base body 14, or 16 to 18, can be embodied to be C-shaped, U-shaped, round, oval or polygonal in cross section. The cross section of the cylinder groove 03 is matched to the respective cross section of the base body 14, or 16 to 18.

The cross section of the base body 14, 16 to 18 represented in drawing FIGS. 1 and 2 is embodied in a C-shape. One of its openings points approximately in the direction of the fastening slit 09. The above mentioned elements, which are arranged so that they can be brought into or out of operating connection with the suspension legs 6, 7, or 24, 28, project through the said opening.

The first clamping and/or jamming elements C consist of a flap 27, which is pivotably seated in the base body 14 or 16 to 18 and whose longitudinal axis extends in an axis-parallel direction, and whose vertical axis extends in the radial direction in respect to the cylinder 01. The lower side 28 of the flap 27 remote from the cylinder surface enters into a slit 29 of the respective base body 14, or 16 to 18, and in this way forms a pivot bearing.

The flap 27 has an axial length l, which corresponds approximately to one-third of the total axial length of a base body 16, 17 or 18 (FIG. 4). The upper side 31 of the flap 27 close to the cylinder surface has a cutout 32, which is limited on both sides by a respective arm 33, 34. Each arm 33, 34 has an axial length m with a jamming surface 36, 37. The axial length m corresponds approximately to one-fourth of the total axial length l of the flap 27. Each of the jamming surfaces 36, 37 is in an operational connection with a respective jamming surface of the abutment 38, 39 of the base body 14, or of the respective base bodies 16 to 18 (FIGS. 1 and 4). The jamming surfaces of the abutment 38, 39 are located in the radial direction below the fastening slit 09. As represented in FIGS. 2, 3, the arms 33, 34 of the flap 27 can be bent off, approximately at right angles, pointing in the direction of the abutment 38, 39.

The pivotable flap 27 can be brought from a plate-holding position into a plate-removing position against the force of a spring 41, for example a compression spring fixed in place on the base body.

Actuation of the pivotable flap 27 takes place by means of an inflatable air hose 42, which will be described later.

The second clamping and/or jamming elements D for a beveled suspension leg 06 of the plate 02 “leading” toward the right in the production direction A consist of a flap 43, which is pivotably seated in the base body 14 or 16 to 18 and extends, kept at a distance by the air hose 42, parallel with the flap 27 (FIG. 1). A lower side 44 enters into a slit 46 of the respective base body 14, or 16, or 18, and constitutes a pivot bearing.

The flap 43 has an axial length of n. This approximately corresponds to the length of the cutout 32, and to twice the axial length m.

The top 47 of the flap 43, which is near the cylinder surface, is bent at approximately right angles in the direction toward the first groove wall 12, and its edge 49 projects into the cutout 32 of the flap 27 located between the arms 33, 34 (force application side). A roller body, for example a jamming roller 48, is maintained in the cutout 32, and is pressed against the “leading” suspension leg 06 resting against the first groove wall 12 by means of the edge 49 of the flap 43 and the force of a spring 51, for example a compression spring fixed in place on the base body.

Actuation of the pivotable flap 43 takes place by means of the inflatable air hose 42 located between the two flaps 27, 43, which can pivot, i.e. open, both flaps 27, 43 against the force of the springs 41, 51.

The third clamping and/or jamming elements E for a beveled suspension leg 06 of the plate 23 (FIG. 2) “leading” toward the left in the production direction B consist of a flap 52, which is pivotably seated in the base body 14 or 16 to 18 of a length l. A second flap 53 of equal length extends parallel with the flap 52 and is kept at a distance by the air hose 42. Both flaps 52, 53 are respectively seated at their lower, i.e. remote from the cylinder, sides 54, 56 in a slit 57, 58 of the respective base body 14, or 16 to 18, and can be actuated against the force of springs 59, 61, for example compression springs.

By means of its jamming surface or edge 63 extending in the axial direction, a top 62 is indirectly, i.e. with the interposition of a jamming roller 64, in an operative connection with the second groove wall 13, or a “leading” suspension leg 24 of the plate 23, resting against it. Here the edge 63 of the top 62 is bent at approximately right angles, pointing in the direction of the second groove wall 13. The jamming roller 64 is supported by an upper lateral face 66 of the flap 53. The base body 14 or 16 to 18 has a cutout 67 in the area of the jamming roller 64.

The clamping and/or jamming elements C, D, E are arranged in an axial length of each base body 16 to 18, and therefore also in the one-piece base body 14, in such a way that the length of a base body 16, 17 or 18 of 3 l corresponds to a number of lengths l, m, n of the clamping and/or jamming elements (FIG. 4):

3 l=4 m for C+2 n for D+l for E

The clamping and/or jamming elements C for the “trailing” suspension leg 07 or 24 are used with each jamming of the plates 02 or 23. When using a plate 02 and the direction of rotation A of the cylinder 01, the clamping and/or jamming elements D for the suspension leg 06 are additionally put into operation. But if a plate 23 is used when the cylinder 01 turns in the direction of rotation B, the clamping and/or jamming elements E are employed in place of the clamping and/or jamming elements D.

The base body 14, or the shorter base bodies 16 to 18, are preferably arranged in a manner fixed against relative rotation in the cylinder groove 03.

The inflatable air hose 42 extends in one piece over the entire length of the cylinder groove 03. On one of its ends, the air hose 42 is provided with a valve, for example, and is charged with compressed air when needed via a connection line, not represented, to the cylinder journal, and by means of a known rotary lead-in.

If the device is intended to be brought from the plate holding position or position of rest (FIG. 1) into the plate-removing, or operating position (FIG. 3), the air hose 42 is charged with compressed air at approximately six bar. By means of this the plates 27, 43 and 52, 53 are pivoted away from each other against the force of the springs 41, 51 and 59, 61. In the course of this, the suspension legs 06, 07, or 24, 26, are released (FIG. 3).

In accordance with a preferred embodiment variation, the force of the pressure of each spring 51, as well as 59, 61, is respectively greater than the force of the pressure of the spring 41. Initially, the air hose 42 is charged with an air pressure of approximately three bar. Therefore the force of the pressure exerted by the air hose 42 is greater than the force of the pressure of the spring 41 and less than the force of the pressure of the springs 41, 59 or 61. The flap 27 is pivoted and the jamming surfaces 36, 37 come out of contact with the rear suspension leg 07, or 26. The “trailing” end can snap out of the fastening slit 09 because of the inherent tension of the plate 02, or 23 with its suspension leg 07 or 26 and can thereafter be grasped.

The result of increasing the air pressure in the air hose 42 to approximately six bar is that the force of the pressure exerted by the air hose 42 now is also greater than the force of the pressure of the springs 41, 59 or 61, so that the suspension leg 06, or 24, is also released.

List of Reference Numerals

| | |
|---|---|
| 01 | Cylinder |
| 02 | Plate |
| 03 | Cylinder groove |
| 04 | Edge (03) |
| 05 | — |
| 06 | Suspension leg (02) |
| 07 | Suspension leg (02) |
| 08 | Edge (03) |
| 09 | Fastening slit (06, 07) |
| 10 | — |
| 11 | Surface (01) |
| 12 | Groove wall (03), first, abutment (49, 48) |
| 13 | Groove wall (03), second, abutment (66, 64) |
| 14 | Base body |
| 15 | — |
| 16 | Base body |
| 17 | Base body |
| 18 | Base body |
| 19 | Set of teeth |
| 20 | — |
| 21 | Set of teeth |
| 22 | Interior (14, 16 to 18) |
| 23 | Plate |
| 24 | Suspension leg (23) |
| 25 | — |
| 26 | Suspension leg (23) |
| 27 | Flap (C) |
| 28 | Side, lower (27) (C) |
| 29 | Slit (16 to 18) (C) |
| 30 | — |
| 31 | Side, upper (27) (C) |
| 32 | Cutout (27) (C) |
| 33 | Arm (27) (C) |
| 34 | Arm (27) (C) |
| 35 | — |
| 36 | Jamming surface (33) (C) |
| 37 | Jamming surface (34) (C) |
| 38 | Abutment (14, 16 to 18) (C) |
| 39 | Abutment (14, 16 to 18) (C) |
| 40 | — |
| 41 | Spring (27) (C) |
| 42 | Air hose (C, D, E) |
| 43 | Flap (D) |
| 44 | Side, lower (43) (D) |
| 45 | — |
| 46 | Slit (16 to 18) (D) |
| 47 | Side, upper (D) |
| 48 | Jammning roller (D) |
| 49 | Edge, jamming surface (43) (D) |
| 50 | — |
| 51 | Spring (43) (D) |
| 52 | Flap (E) |
| 53 | Flap (E) |
| 54 | Side, lower (52) (E) |
| 55 | — |
| 56 | Side, lower (53) (E) |
| 57 | Slit (16 to 18) (E) |
| 58 | Slit (16 to 18) (E) |
| 59 | Spring (52) (E) |
| 60 | — |
| 61 | Spring (53) (E) |
| 62 | Side, upper (52) (E) |
| 63 | Edge, jamming surface (52) (E) |
| 64 | Jamming roller (E) |
| 65 | — |
| 66 | Lateral face, upper (53) (E) |
| 67 | Cutout (14, 16 to 18) (E) |
| A | Production direction |
| B | Production direction |
| C | Clamping and/or jamming element, first (14, 16 to 18) |
| D | Clamping and/or jamming element, second (14, 16 to 18) |
| E | Clamping and/or jamming element, third (14, 16 to 18) |
| f | Width (09) |
| l | Length (27, 52) |
| m | Length (33, 34) |
| n | Length (48) |
| alpha | Opening angle (11, 12; 11, 13) |
| beta | Opening angle (02, 07; 23, 26) |

1. A device for fixing a flexible plate (02, 23) with suspension legs (06, 07; 24, 26) on a cylinder (02) of a rotary printing press, wherein first fastening elements (C) for the trailing suspension leg (07, 26), and second fastening elements (D) for a suspension leg (06) leading in a first production direction (A) are arranged in a cylinder groove (03), characterized in that third fastening elements (E) for a suspension leg (24) leading in a second production direction (B) are arranged.

2. The device in accordance with claim 1, characterized in that the leading suspension leg (06; 24) is approximately arranged at a respectively acute angle.

3. A device for fixing a flexible plate (02, 23) with suspension legs (06, 07; 24, 26) on a cylinder (02) of a rotary printing press, having a fastening slit (09), wherein the fastening slit (09) terminates in the radial direction in a cylinder groove (03), and fastening elements (C, D, E) are arranged in the cylinder groove (03), wherein a leading suspension leg (06, 24), which is beveled at an acute angle, is interlockingly fastened between an abutment (12) fixed in place on the groove wall, and a fastening element (D, E), characterized in that the fastening element (D, E) is embodied as a pivotable flap (43), that at least one roller body, in particular a jamming roller (48, 64), is arranged between this pivotable flap (43) and the suspension leg (06, 24), which is beveled at an acute angle.

4. The device in accordance with claim 1 or 3, characterized in that at least one base body (14, 16, 17, 18), which is open in the direction toward the fastening slit, is arranged in the cylinder groove (03).

5. The device in accordance with claim 4, characterized in that parts of the fastening elements (C, D, E), which can be brought into or out of an operative connection with the suspension legs (06, 07, 24, 26), project through an opening in the base body (14, 16, 17, 18).

6. The device in accordance with claims 1 or 3, characterized in that the fastening elements (C, D, E) are arranged so that they can be brought out of an operative connection with the suspension legs (06, 07, 24, 26) by means of an inflatable air hose (42).

7. The device in accordance with claim 4, characterized in that the base body (14, 15 to 18) has a C-shaped or polygonal cross section.

8. The device in accordance with claim 4, characterized in that the base body (14) consists of several short base bodies (16, 17, 18) in the axial direction, which can be coupled with each other.

9. The device in accordance with claim 4, characterized in that the base body (14, 15 to 18) is arranged in the cylinder groove (03) fixed against relative rotation.

10. The device in accordance with claim 4, characterized in that the sum of the jamming surfaces provided by the fastening elements (C, D, E) in a base body (14, 15 to 18) is of approximately equal length.

11. The device in accordance with claim 1 or 3, characterized in that first fastening elements (C) for the “trailing” suspension leg (07, 26), which is bent at approximately right angles, consist of a pivotably seated flap (27), whose jamming faces (36, 37) are in an operative connection with an abutment (38, 39) fixed in place in the base body, that the flap (27) is arranged so it can be brought out of engagement with the abutment (38, 39) by means of the inflatable air hose (42) against the force of at least one spring (41).

12. The device in accordance with claim 11, characterized in that the air hose (42) is supported against a resilient abutment (38, 39).

13. The device in accordance with claims 1 or 3, characterized in that second fastening means (D) for a suspension leg (06, 24), which is “leading” toward the right (A) and is beveled at an acute angle, consist of a pivotably seated plate (43), whose jamming face (49) is in an operative connection with an abutment (12) fixed in place in the base body, that the flap (43) is arranged so it can be brought out of engagement with the abutment (12) by means of the inflatable air hose (42) against the force of at least one spring (51).

14. The device in accordance with claim 13, characterized in that the air hose (42) is supported against a resilient abutment (27, 41).

15. The device in accordance with claims 13 and 14, characterized in that at least one roller body, for example a jamming roller (48), is arranged between the jamming surface (49) and the abutment (12) fixed in place in the wall of the base body.

16. The device in accordance with claim 3 and 13, characterized in that the roller body, for example the jamming roller (48), is guided in a cutout (32) of the flap (27) of the fastening elements (C).

17. The device in accordance with claim 13, characterized in that the free end of the flap (43) having the jamming surface (49), is bent in the direction of the oppositely located groove wall (12).

18. The device in accordance with claim 1, characterized in that third fastening elements (E) for a suspension leg (24), which is “leading” in the opposite direction (B) and is beveled at an acute angle, consist of a pivotable seated flap (52), whose jamming surface (63) is in an indirect operative connection with an abutment (13) fixed in place on the groove wall, that the flap (52) is arranged so it can be brought out of engagement with the abutment (13) by means of the inflatable air hose (42) against the force of at least one spring (59).

19. The device in accordance with claim 18, characterized in that the air hose (42) is supported against a resilient abutment (53, 61).

20. The device in accordance with claim 18, characterized in that at least one jamming roller (64) is arranged between the jamming surface (63) and the abutment (13) fixed in place in the wall of the base body.

21. The device in accordance with claims 18 and 20, characterized in that the jamming roller (64) is guided in a cutout (67) of the base body (14, or 16 to 18) and is supported on an upper lateral face (66) of the abutment (53).

22. The device in accordance with claim 1 or 3, characterized in that a force of pressure of each spring (51, 59 or 61) of the fastening elements (D, E) of the leading suspension leg (06, 24) is respectively greater than the force of pressure of each spring (41) of the fastening elements (C) of the trailing suspension leg (07, 26).

23. The device in accordance with claim 1 or 3, characterized in that the respective trailing suspension leg (07, 24) is bent at approximately right angles.
